(19) United States
(12) Patent Application Publication
(10) Pub. No.: US 2002/0103684 A1
(43) Pub. Date: Aug. 1, 2002

(54) Program and method for providing a delivery date, and recording medium thereof

(75) Inventor: Yukio Murata, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/057,882

(22) Filed: Jan. 29, 2002

(30) Foreign Application Priority Data
Jan. 31, 2001 (JP) 2001-024774

(51) Int. Cl. G06F 17/60

(52) U.S. Cl. 705/7

(57) ABSTRACT

The purpose of the present invention is to improve customer service and to promote sales activities by notification of a delivery date (guarantee value) for customer's requirement information, by presenting a delivery date (guarantee value) for a requirement information from a customer, and making an automatic allocation according to such a delivery date (guarantee value) upon receiving a formal order while automatically erasing the guarantee value that is not available for the formal order.

A method of the invention include the steps of: entering the requirement information of a product from the customer; supplying the customer with a provisionally allocated shipment guarantee value for the above entered requirement information; receiving a formal order-receiving information of the product from the customer; and formally allocating an applicable said guarantee value to the above-received formal order-receiving information.

### FIELD OF THE INVENTION

The invention herein presented relates to a method for providing a delivery date for giving a customer a delivery date, to a program for providing a delivery date, and to a recording medium.

### BACKGROUND OF THE INVENTION

In the unit assembling industry, providing a delivery date has been done in a way that the order information is registered in a system at a time when an order from the customer, such as distributor or agency, is received and, subsequently, the delivery date for the order information is provided.

When products are produced according to expected demand, the requirement information provided by the customer (information on expected demand for the products) required to allow a shorter lead time.

The requirement information presented by the customer, however, is one-way information and no delivery date is provided. In this circumstance, there has been a demand for a delivery date in answer to the requirement information and an applicable delivery date in answer to the formal order-receiving information.

### SUMMARY OF THE INVENTION

Herein, a summary of the present inventions to solve the above problem is as follows.

A method of providing a delivery date for order-received products to customer comprises a step of entering a requirement information of products from the customer, a step of providing to the customer a shipment guarantee value which is provisionally allocated to a volume of products for a order included in the requirement information, a step of receiving a formal order-receiving information of the products from the customer in response to the shipment guarantee value, and a step of formally allocating said applicable shipment guarantee value based on the order included in the formal order-receiving information.

And, in the step of formally allocating, when the provisionally allocated shipment guarantee value exceeds the formally allocated guarantee value, a portion of the excess is used for other formal allocation, and when the provisionally allocated shipment guarantee value falls short in comparison with formal allocation, a portion of the shortage is allocated to a new formal order-receiving. The shipment guarantee value is deleted on or after a deadline delivery date for the order-receiving which is calculated from the shipment guarantee value.

The present invention relates to a program for providing delivery date for order-receiving products to a customer and a computer readable recording medium having recorded therein a program for providing a delivery date for order-receiving products to the customer.

According the present inventions as mentioned above, when the requirement information from the customer for products is entered, a provisional shipment guarantee value for a provisionally received order is produced and is provided to the customer. When the formal order-receiving information for products is entered, an applicable delivery date (guarantee value) for the formal order is allocated. On this occasion, on the basis of the formal order, when the provisionally allocated shipment guarantee value exceeds the applicable guarantee value, a portion of the excess is allocated as another formal order, and when the provisionally allocated shipment guarantee value falls short in comparison with the applicable guarantee value, a portion of the shortage is allocated as a new formal order. As the shipment guarantee value is deleted on or after a deadline delivery date for the order-receiving which is calculated from the shipment guarantee value, products comprising unnecessary stock can be automatically eliminated from a production plan.

Thus, an improvement in customer service and the promotion of sales activities become possible by providing the customer with a delivery date in response to his requirement information. When the formal order from customer is received, the delivery date allocation for the order is automatically performed in accordance with the guarantee value. The shipment guarantee value for products which have not been ordered is automatically deleted. By providing the customer with a delivery date in response to the requirement information, the service to the customer is improved, and sales activity is promoted.

### DESCRIPTION OF THE DRAWINGS

FIGS. 1A and 1B are a graphical representation of a constitution showing one embodiment of this invention.

FIG. 2 is a flow chart (part 1) representing an operation of this invention.

FIGS. 3A and 3B are flow charts (part 2) representing an operation of this invention.

FIGS. 4, and 4A to 4D are a graphical representation of this invention (part 1)

FIGS. 5A and 5B are a graphical representation of this invention (part 2).

FIGS. 6A and 6B are a graphical representation showing the general concept of this invention.

### DETAILED DESCRIPTION OF THE INVENTION

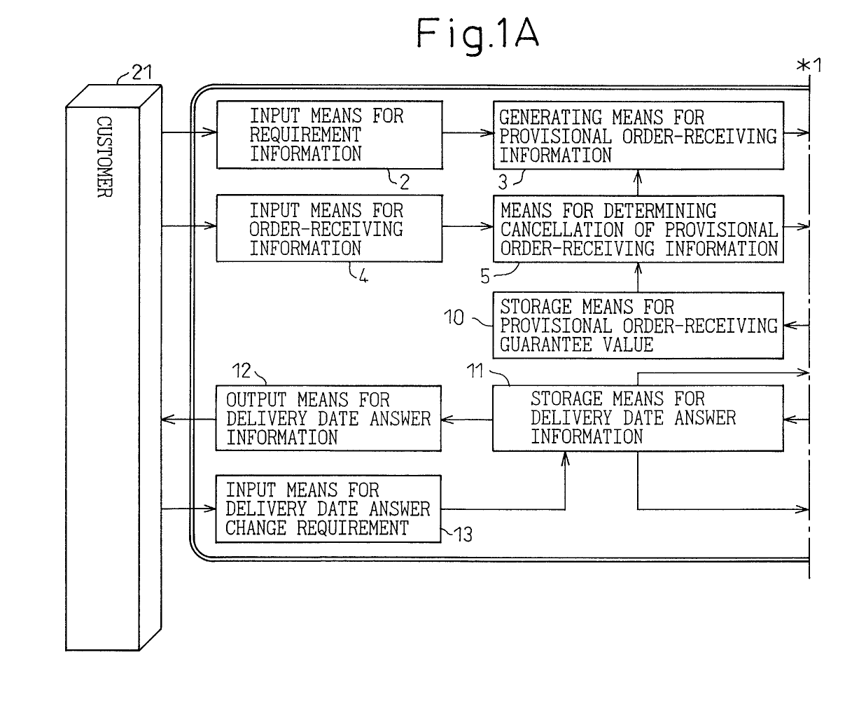

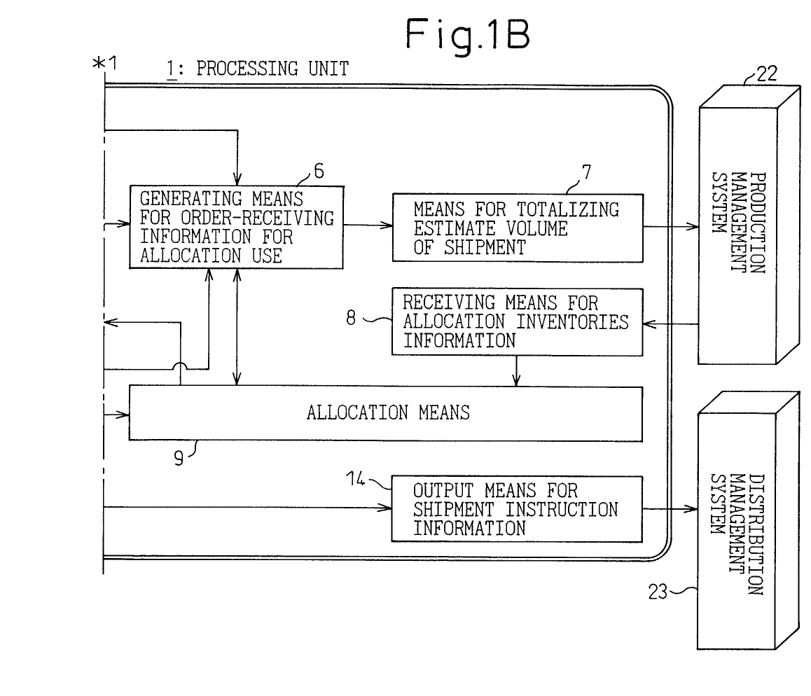

Next, a specific description relating to the embodiment and processing operation of this invention is sequentially presented by referring to FIG. 1 to FIG. 6.

FIGS. 1A and 1B represent a whole constitution of one embodiment of this invention. In FIG. 1, the processing unit 1, in compliance with the program, performs the allocation process and provides the delivery date based on the information of the requirement and order-receiving. The processing unit 1 consists of means 2 to 14 shown in the figure.

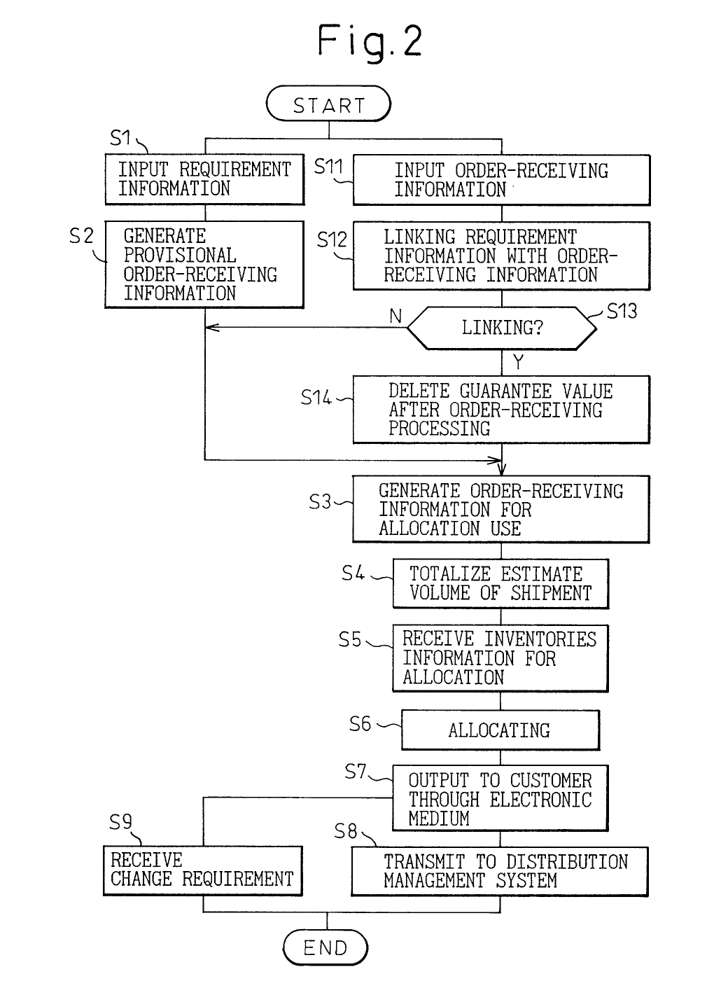

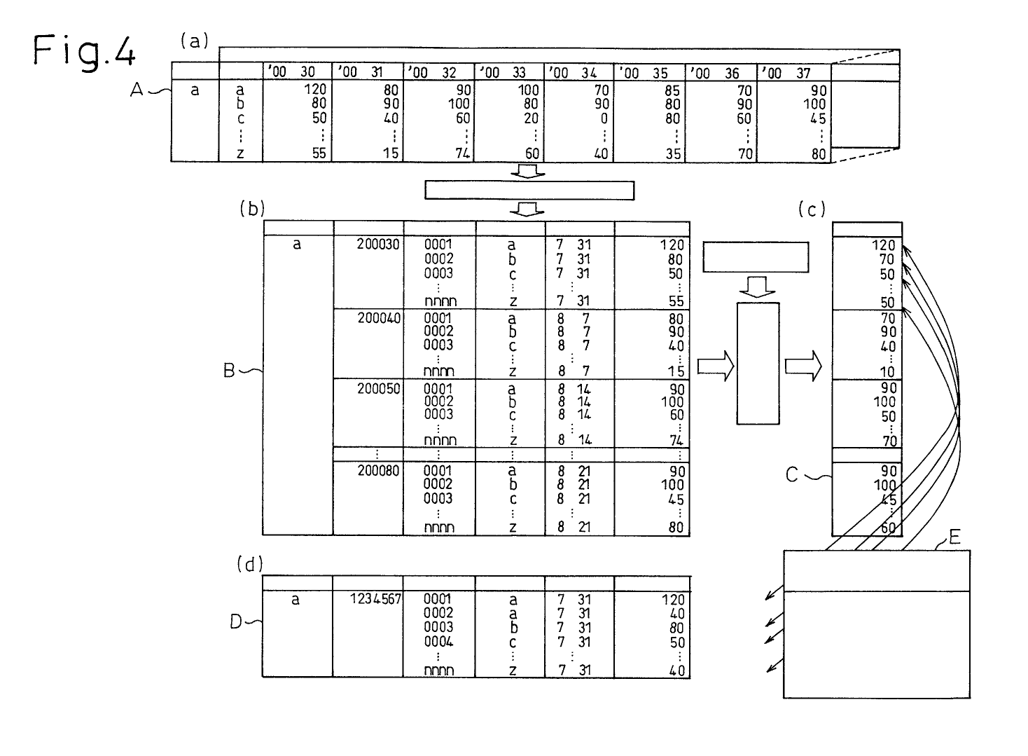

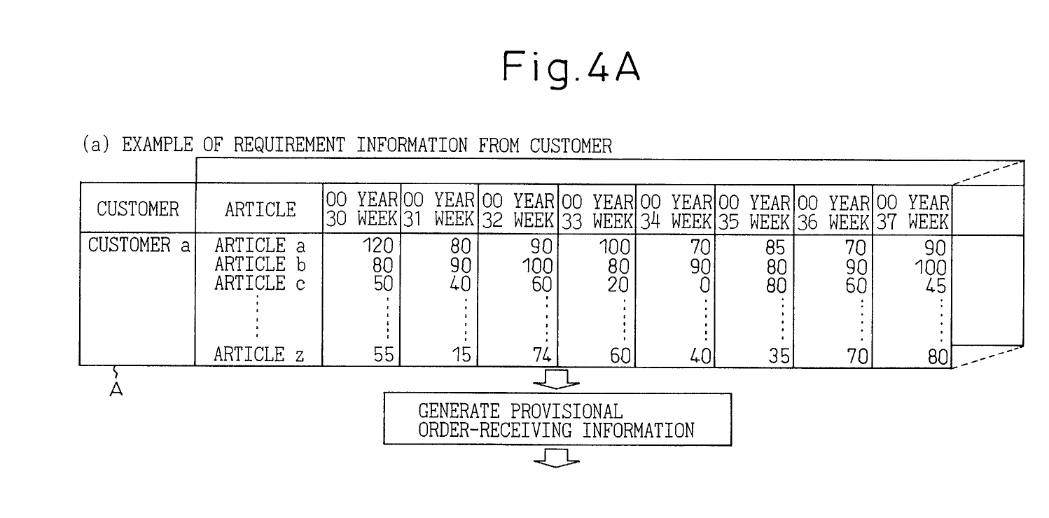

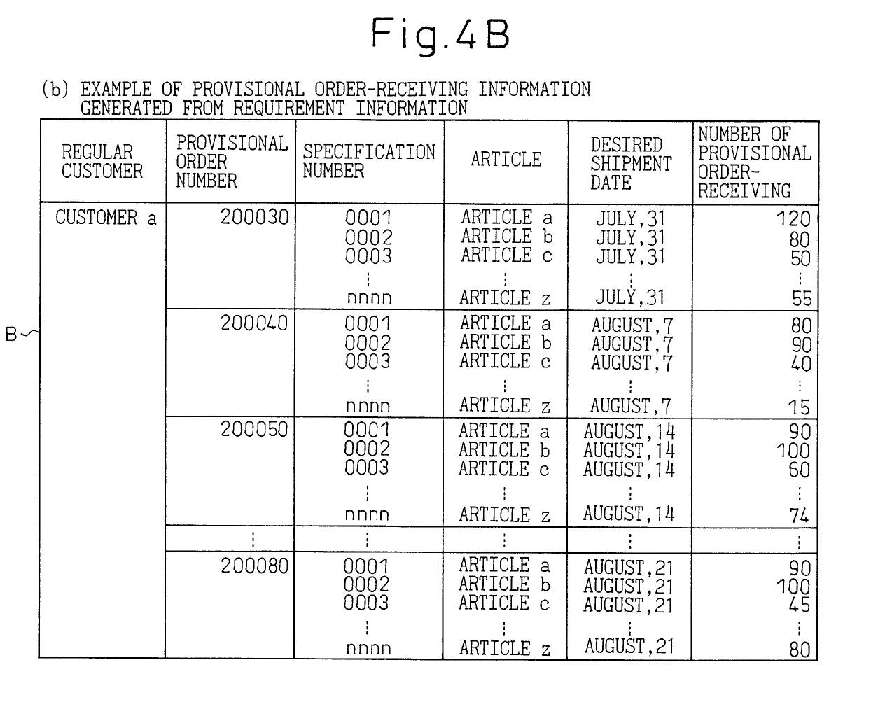

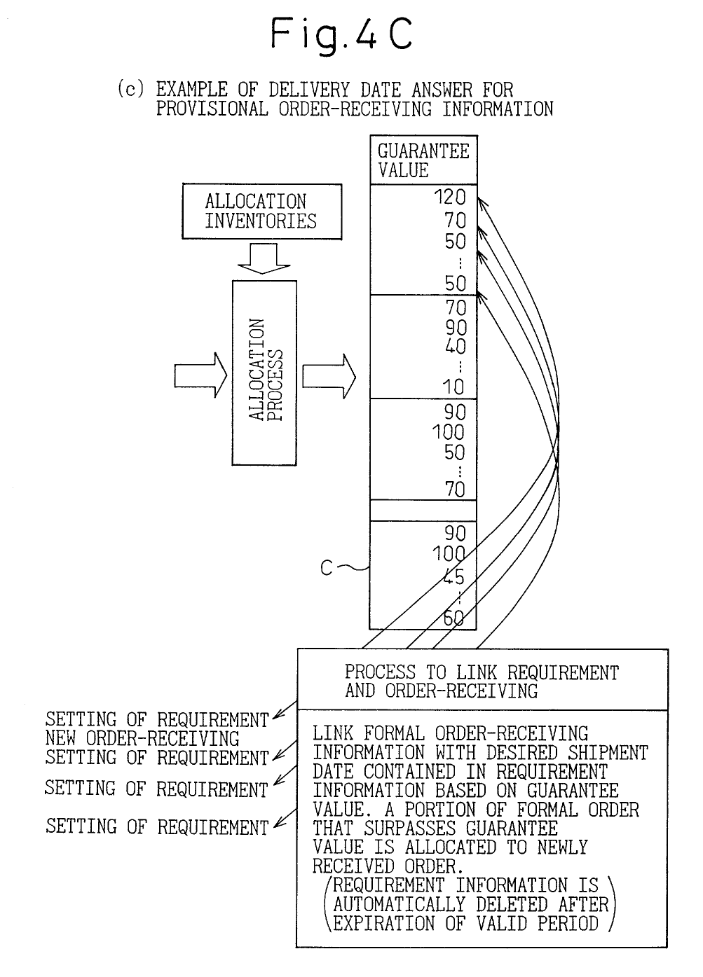

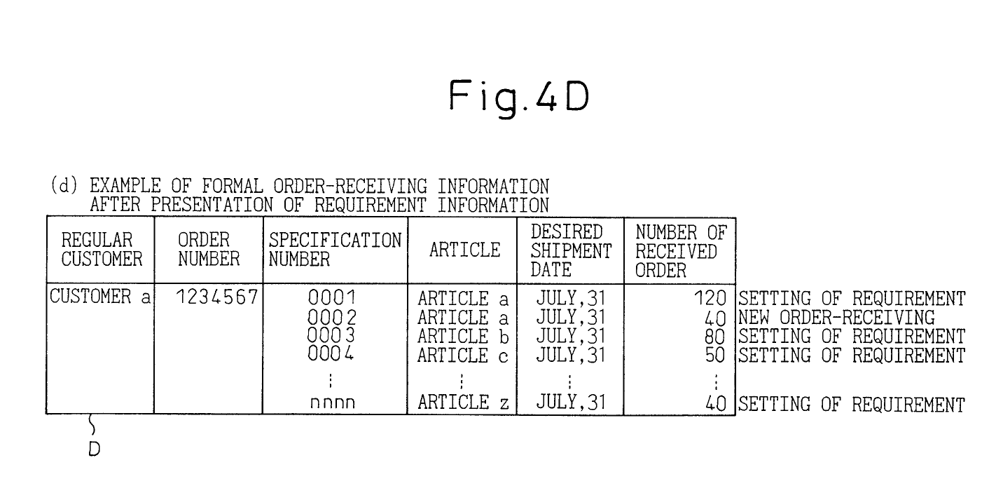

A requirement information input means 2 is a means for inputting the requirement information of the customer 21 transmitted by the customer 21 via the network (not shown in figures). A generating means 3 of provisional order-receiving information is a means for generating a provisional order-receiving information from the customer's requirement information (reference can be made to Step 2 in FIG. 2 and FIG. 4B to be described later).

An order-receiving information input means 4 receives the formal order-receiving information of the customer 21 transmitted by the customer 21 via the network. A determination means 5 for canceling provisional order-receiving information is a means for determining whether the provisional order-receiving information, generated from customer's requirement information, is to be canceled or not according to the formal order-receiving information.

A generating means 6 of allocation order-receiving information generates the order-receiving information for allocation based on the information of the provisional order-receiving and the delivery date answer. A means for totalizing estimated shipment volume 7 totalizes the order-receiving information for allocation and generating an estimated shipment volume.

An allocation inventories information receiving means 8 receives the allocation inventories information from a production management system 22. An allocation means 9 generates, based on the information including the order-receiving for allocation and the delivery date answer, the allocation, the guarantee value for provisional order-receiving, and the delivery date answer. On this, the guarantee value is the information that guarantees the shipment volume will be delivered by the delivery date.

A storage means 10 of the provisional order-receiving guarantee value stores the guarantee value for delivery date (guarantee value for provisional order-receiving), which is allocated to the provisional order-receiving information generated from customer's requirement information. A storage means 11 of delivery date answer information stores the delivery date answer information for the customer.

An output means 12 of delivery date answer information notifies the customer 21 of the delivery date information via the network. An input means 13 of delivery date answer change requirement receives customer's requirement for delivery date change via the network of the customer 21.

An output means 14 of shipment instruction information outputs the shipment instruction information, generated from the delivery date answer information, to a distribution management system 23. The customer 21 is the customer (distributors and agencies) purchasing the products, which is represented here as the terminal device for the customer 21 connected via the network.

The production management system 22 manages the production and outputs the allocation inventories information based on the estimated shipment volume. The distribution management system 23 is the system for distributing the products to the customer according to the shipment instruction information.

Next, the operations performed in the constitution shown in FIG. 1 is to be sequentially described, with referring to FIG. 2 to FIG. 6. FIG. 2 is a flow chart (part 1) representing the operations performed in this invention. At step 1 shown in FIG. 2, the requirement information is entered from the customer 21. Step 1 represents that the customer 21 shown in FIG. 1 enters his or her requirement information—for example, such as the requirement information shown in FIG. 4A to be described later, articles and volume of products, delivery date to each customer—into the processing unit 1.

The provisional order-receiving information is generated at Step 2, wherein the provisional order-receiving information—for example, such as the provisional order-receiving information shown in FIG. 4B, articles of products, order number, specification and desired delivery date to each customer—is generated based on the customer's requirement information entered at Step 1. The order-receiving information for allocation is generated with the provisional order-receiving information at Step 3. In Step 3, the delivery date of which an allocation process for inventories has been made guarantee value for a case of provisional order-receiving, or delivery date for a case of formal order-receiving) is generated for the provisional order-receiving information generated at Step 2 (or an order-receiving information without linking, which is entered at Step 11 and is on a NO flow at Step 13). Then, the order-receiving information for allocation, which corresponds to the generated delivery date mentioned above, is generated.

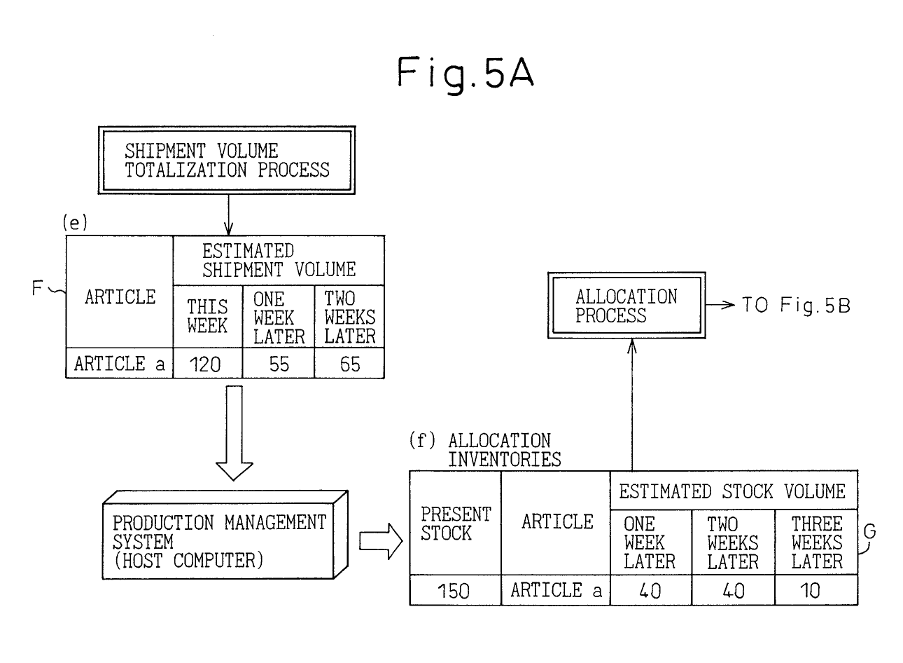

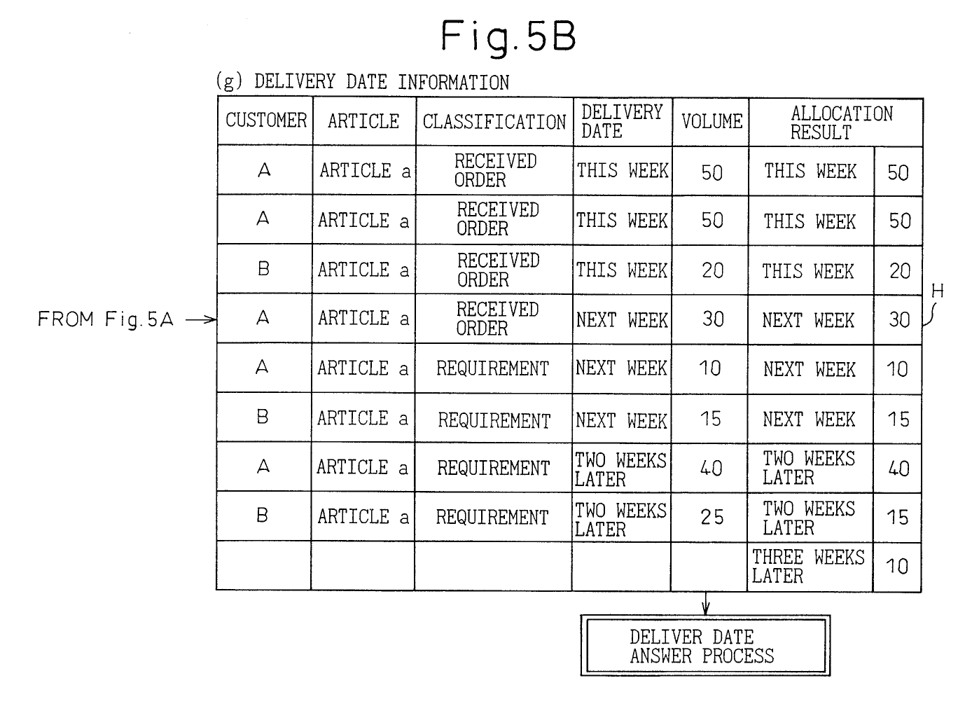

The shipment volume of the product is totalized at Step 4, wherein the shipment volume to be shipped, as shown in FIG. 5 (e) to be described later, is totalized. This means that the order-receiving information for allocation generated at Step 3 is collected and the estimated shipment volume of the product is generated.

The allocation inventories information is received at Step 5, wherein the allocation inventories information is received from the production management system that will be shown in FIG. 5 later. The allocation process to the order-receiving information is performed at step 6, wherein the allocation inventories received at Step 5 is sequentially allocated to the estimated shipment volume generated at Step 4. For example, the sequential allocation process generates the delivery date information that will be shown in FIG. 5 (g) to be described later.

Output for the customer via an electronic medium is performed at Step 7. The output via the electronic medium is an example of notifying the customer of the allocation result generated at Step 6. Transmitting the allocation result to the distribution management system is performed at Step 8, wherein the shipment instruction information according to the allocation result is transmitted to the distribution management system 23 shown in FIG. 1.

The change requirement might be used by the customer at Step 9. When the customer 21 sends the change requirement information corresponding to the notification of the allocation result, the change requirement is received from the customer. According to the change requirement, the notified delivery date is modified, and a reallocation process is performed.

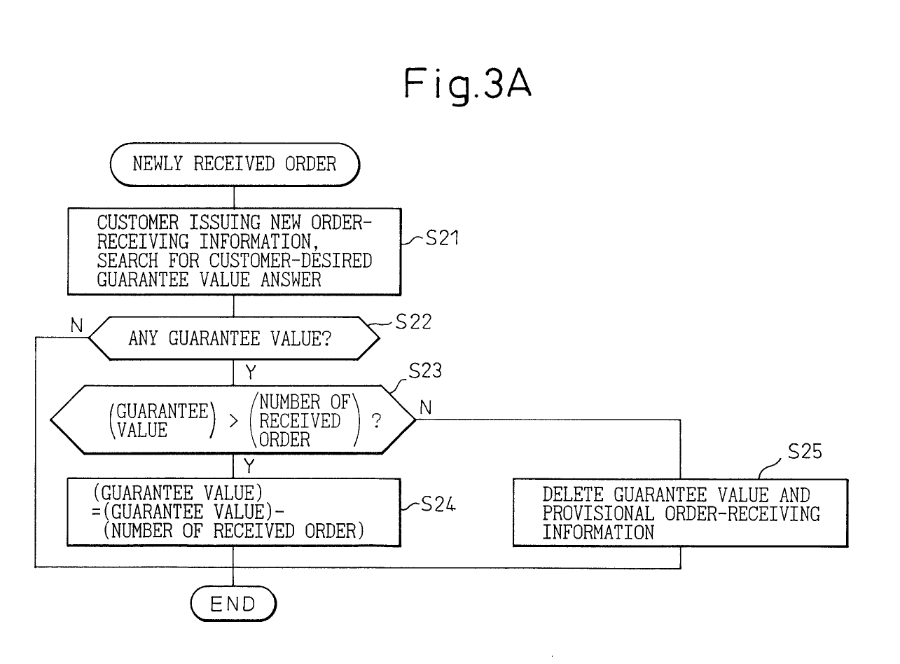

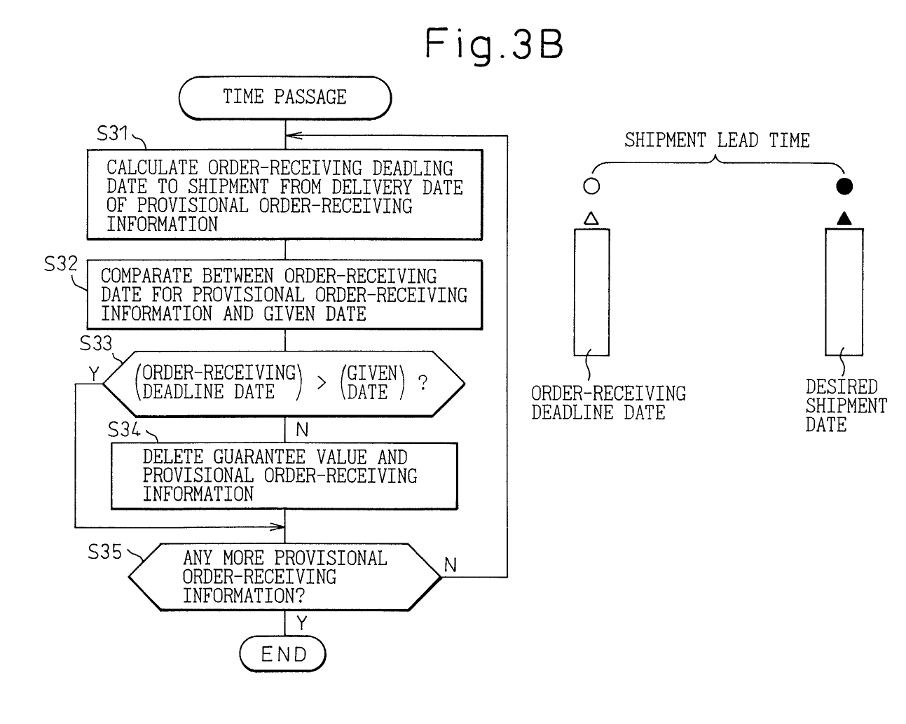

As was stated above, the provisional order-receiving allocation is performed upon entering customer's requirement information, in response to the information, the delivery date answer as the shipment guarantee value is notified to the customer. When the formal order-receiving is subsequently made, the exact delivery date is given to the customer by allocating the applicable guarantee value as the formal order-receiving. It is also possible that, as it will be shown in FIGS. 3A and 3B later, when the received formal order is within the guarantee value, the applicable guarantee value is allocated, and the formal delivery date answer according to the guarantee value is sent to the customer, while when the guarantee value is not sufficient for the received formal order, the portion short is allocated, as a newly received order, with processes of Step 11, Step 12, and Step 13 for providing the formal delivery date. As it will be described later in FIG. 3B, the applicable guarantee value is to be deleted on or after the deadline date which is calculated from the guarantee value, and the provisionally allocated guarantee value based on customer's requirement information is also automatically deleted. With the deleting mentioned above, products comprising unnecessary stock can be automatically eliminated from a production plan.

FIGS. 3A and 3B are flow charts (part 2) representing the operation performed in this invention. FIG. 3A is a flow chart representing an operation when the shipment guarantee value is allocated based on the formal order-receiving information.

At Step 21 in FIG. 3A, a customer with new order-receiving information, as well as a guarantee value answer for the delivery date the customer desired, are searched for. Finding the shipment guarantee value for the ordered products is performed at Step 22. This means that whether the guarantee value, which is an answer for the desired delivery date for the customer with the newly received order information, is found or not, is determined. YES at Step 22 represents the finding of the answer for the guarantee value, corresponding to the desired delivery time for the customer with new order-receiving information. Therefore, a further step is taken at Step 23. On the other hand, the allocation process comes to the end with NO at Step 22.

At step 23, (guarantee value)>(number of received order) is determined. As a YES determination means the guarantee value is larger than the volume of received order, Step 24 follows. A substitution equation, (guarantee value)=(guarantee value)−(number of received order), at Step 24 means the determined guarantee value is updated by subtracting the number of received order from itself. Since updated guarantee value is applicable to the received order, it is allocated to the received order and the allocation process comes to the end. On the other hand, NO at Step 23 indicates that the guarantee value is smaller than the volume of received order, which leads to the deleting of the guarantee value and the provisional order-receiving information at Step 25. At the same time, the applicable guarantee value is allocated (a process following Step 11, Step 12, and YES result at Step 13 shown in FIG. 2), and a portion of the shortage of the guarantee value is allocated as the newly received order (a process following Step 11, Step 12, and NO result at Step 13 shown in FIG. 2).

Thus, to the formal order-receiving information from the customer, the guarantee value is allocated if the volume of the received order is within the shipment guarantee value. If the guarantee value is not enough to cover the formal order-receiving information, the portion of shortage can be allocated as the newly received order. If the guarantee value is not available, the whole formal order-receiving information can be allocated as a newly received order.

FIG. 3B is a flow chart representing the operation in which the applicable guarantee value is automatically deleted on or after the deadline date calculated from the guarantee value. At Step 31 shown in FIG. 3B, the order-receiving deadline date, before which a shipment is available, is calculated from the delivery date indicated in the provisional order-receiving information. As shown on the right side in FIG. 3B, the possible deadline date, corresponding to the delivery date indicated in customer's provisional order-receiving information (the shipment guarantee value), is calculated by subtracting shipment lead time from desired shipment date.

At Step 32, a given date is compared to the deadline date calculated according to the provisional order-receiving information. At Step 33, (the order-receiving deadline date)>(a given date), is determined. A YES determination indicates that the date of the guarantee value has not arrived at the date to be deleted, and Step 35 follows. On the other hand, a NO determination indicates that a given day coincides with the deadline date. Then the guarantee value and the provisional order-receiving information are deleted at Step 34 to avoid starting production without having formally received an order, and when these are a plurality of provisional order-receiving informations, Step 35 follows.

At Step 35, whether all provisional order-receiving information has been processed is determined. A YES determination leads to the end of the flow. Moreover, when the determination is NO, the operation is returned to Step 31, where the loop process starts again. Thus following operation become possible: wherein, calculating the order-receiving deadline date from the guarantee value, automatically deleting the guarantee value (and the provisional order-receiving information) on or after the order-receiving deadline date, so that, as to the generated provisional order-receiving information based on customer's requirement information and the guarantee value allocated to it, an unallocated value (a guarantee value to which no formal order allocated) is automatically deleted on or after the deadline date to avoid unnecessary stocking caused by the guarantee value to which no formal order is allocated.

FIG. 4 and FIG. 5 are graphical representations for this invention. FIG. 4A shows an example of the requirement information from the customer by table form A. This table A represents the customer's requirement information entered at Step 1 described in FIG. 2 before. The following each information items are shown in table A corresponding to each customer.

customer's name (customer's ID):

article:

required weeks:

volume:

other specifications:

In FIG. 4A, information of each customer, indicating which article and what amount will be needed at which week (requirement information), is arranged. According to information indicated in table A, the provisional order-receiving information for each customer is generated.

FIG. 4B shows an example of the provisional order-receiving information made up from the requirement information in table form B. It is made up as the provisional order-receiving information, which meets conditions concerning article, week, and volume required by each customer's requirement information in table A. The made-up information is recorded as shown in table B, and corresponds to the information below.

regular customer's name (customer's name):

provisional order number:

specification number:

article:

desired shipment day:

the number of provisional order-receiving:

other specifications:

The regular customer's name is the customer's name shown in FIG. 4A. The provisional order number is a number given to the corresponding provisional order-receiving. The specification number is a number given to each article recorded in the corresponding provisional order-receiving information. The article is the article described in table A. The desired shipment date represents the required week described in table A. The number of provisional order-receiving represents the required volume (volume) described in table A. As described above, making up of the provisional order-receiving information, which meets customer's requirement information, makes it possible that a provisional order-receiving of each customer is accepted, and an applicable guarantee value is allocated to the provisional order-receiving and given to the customer as the delivery date.

FIG. 4C is an graphical example representing the delivery date answer (shipment guarantee value) for the provisional order-receiving information. The example is indicated in table C. The delivery date answer mentioned above is a result (guarantee value), which is produced after the allocation process of allocation inventories for the provisional order-receiving information in table B is over, wherein an information indicated below is further added to the provisional order-receiving information shown in table B, and is registered.

Shipment guarantee value (delivery date answer):

The guarantee value described here is the delivery date answer (guarantee delivery date answer), which guarantees the delivery date for the provisional order-receiving information. In other words, it is the guarantee delivery date answer guarantee that the applicable guarantee value is to be allocated without fail when the formal order-receiving occurs (FIG. 3A).

FIG. 4D shows an example representing the formal order-receiving information after a presentation of the requirement information by table form D. After the guarantee value shown in table D is given to the customer as an answer, the received order within the applicable guarantee value is securely allocated as the formal order-receiving once the order is formally received. The portion of the formal order that surpasses the guarantee value is allocated as a newly received order (FIG. 3A). As shown in FIG. 4D, according to the given process E shown in FIG. 4C, the formal order-receiving information corresponds to the items described below, and is registered.

regular customer (customer's name):

order number:

specification number:

article:

desired shipment date:

the number of order-receiving:

other specifications:

FIG. 5 (e) shows an example representing the estimated shipment volume by table form F. The guarantee value is allocated based on the formal order-receiving information shown in table D, and the portion of the shortage is allocated as the newly received order. The article, desired shipment date, and volume shown in the Figure are all totalized according to the allocations described above. In table F, the estimated shipment volume is arranged by calculating the corresponding information shown below.

article:

estimated weekly shipment volume:

other specifications:

As shown in the Figure, the volume of the article is totalized and arranged on a weekly basis (this week, next week, second week - - - ) so that the weekly shipment volume of each article for all customers is totalized.

FIG. 5 (f) shows an example representing the allocation material by table form G. As the shipment totalization result shown in table F is notified to the production management system, the system receives the information of the inventories (allocation inventories), which can be produced in the production management system to be allocated. In table G, the allocation inventories information is arranged in correspondence with the items described below.

present stock:

article:

expected stock volume:

one week later:

two weeks later

three weeks later:

The allocation inventories information shown in table G gives information showing the stock of each article and the expected production volume on one week ahead, two weeks ahead, three week ahead - - - (expected production information).

FIG. 5 (g) shows an example representing the delivery date information by table form H, that is to say, an example of the delivery date which is allocated, according to the allocation inventories shown in table G, to each customer's formal order-receiving information. In table H, the delivery date information arranged here corresponds to the information described below.

customer's name:

article;

classification: order-receiving, requirement

delivery date:

volume:

allocation result:

week:

volume:

other specifications:

The delivery date information shown in table H is to be notified, as the delivery date answer, to each customer.

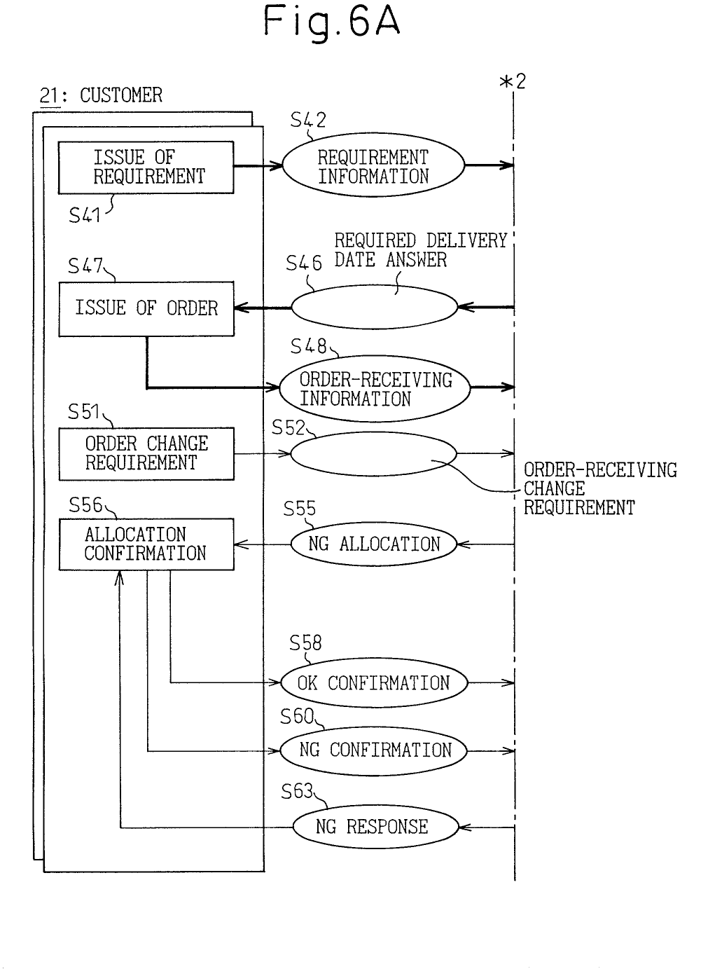

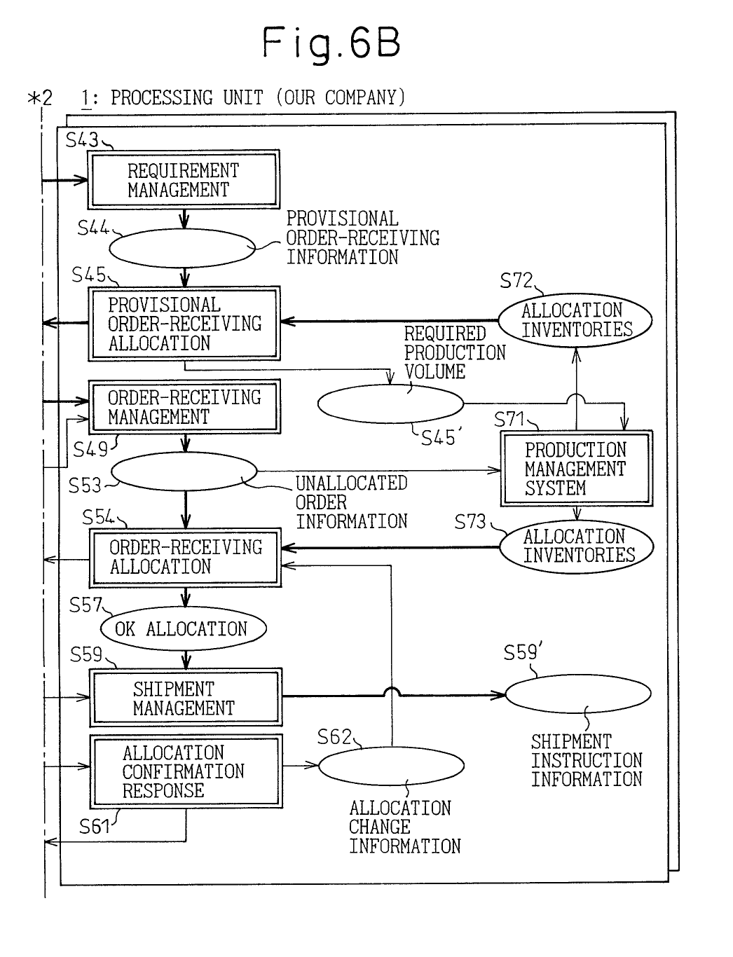

FIG. 6 is a graphical representation showing general concept of this invention. The customer 21 and the processing unit 1 (our company) represents the customer 21 and the processing unit 1 shown in FIG. 1, respectively. First, at Step 41, the customer issues the requirement information.

At Step 42, the requirement information issued from the customer at Step 41 is transmitted to (entered into) the unit 1 (our company) through the network. At Step 43, the requirement information entered at Step 42 is managed.

At Step 44, the provisional order-receiving information is generated. At this Step, the provisional order-receiving information described in FIG. 4B is generated. At Step 45, the provisional order-receiving allocation is performed. At this Step, the provisional allocation described in FIG. 4C is performed and the shipment guarantee value in table C is produced.

At Step 45′, a required production volume is totalized, as the provisional order-receiving allocation is performed, and is notified to the production management system. At Step 46, the delivery date (guarantee value) in response to the requirement information is provided to the customer.

At Step 47, the customer issues the formal order. At Step 48, the order-issuing information is notified to the unit 1 (our company) through the network.

At Step 49, an order-receiving management is performed for the order-issuing information notified at Step 48. At Step 51, when occasion demands, the order-issuing change requirement is issued by the customer. At Step 52, the order-issuing change requirement is notified to (entered into) the processing unit 1 (our company). This notification is received and managed in the order-receiving management.

At Step 53, according to the order-issuing change requirement, remained order information is generated, wherein the information of a remained order is generated under the order-receiving management at Step 49. At Step 54, the order-receiving allocation is performed. Based on the allocation inventories, the allocation for order-receiving is performed according to the remained order information.

At Step 55, a NG allocation is notified to the customer if the NG allocation (allocation impossible, or delayed allocation for the delivery date) has resulted from the allocation performed at Step 54. At Step 56, the customer confirms the NG allocation notified at Step 55.

At Step 57, an OK allocation (success of an allocation coincides with customer-desired delivery date) results from the allocation performed at Step 54. At Step 58, the processing unit 1 (our company) receives the OK confirmation information from the customer, which confirms the allocation at Step 56.

At Step 59, the shipment management processing is performed according to the OK allocation information at Step 57 and the OK confirmation information from the customer at Step 58. At Step 59′, with the shipment management processing at Step 59, the shipment instruction information is notified to the distribution management system 23.

At Step 60, when the NG allocation is not accepted by the customer in the allocation confirmation of Step 56, the processing unit 1 (our company) receives the NG confirmation information from the customer. At Step 61, for the received information, an allocation confirmation response is made. At Step 62, the allocation change information is generated based on the NG confirmation information from the customer, the order-receiving allocation of Step 54 is performed, and at Step 63, the NG response is notified to the customer.

Therefore, the following Steps become possible; generating the provisional order-receiving information (table A in FIG. 4) based on customer's requirement information, which is followed by the provisional allocation for providing the required delivery date (guarantee value, table C in FIG. 4), allocating the required delivery date (shipment guarantee value) to the formal order upon receiving formal order while the guarantee value shortage is allocated as new order-receiving, replying an OK allocation/NG allocation to the customer for confirming by which method the shipment management is made, and notifying the shipment instruction information to the distribution management system 23 to ship the product.

As described heretofore, this invention has a constitution, wherein; the delivery date answer (shipment guarantee value) is presented for customer's requirement information, and, according to such delivery date answer (shipment guarantee value), the automatic allocation is performed upon receiving a formal order while a guarantee value unavailable for the formal order-receiving is deleted. Thus it is possible to improve customer service and to promote sales activities by notifying the delivery date answer (shipment guarantee value) for customer's requirement information.

What is claimed is:

1. A method of providing a delivery date for order-received products to a customer, comprising the steps of:
entering a requirement information of products from the customer;
providing to the customer a shipment guarantee value which is provisionally allocated to a volume of products for a order included in said requirement information;
receiving formal order-receiving information of the products from said customer in response to said shipment guarantee value; and
formally allocating an applicable said shipment guarantee value based on the order included in said formal order-receiving information.

2. A method of providing a delivery date, for order-received products, to a customer according to claim 1, wherein, in the step of formally allocating, when said provisionally allocated shipment guarantee value exceeds the formally allocated guarantee value, a portion of the excess is used for another formal allocation, and when said provisionally allocated shipment guarantee value falls short in comparison with a formal allocation, a portion of the shortage is allocated to a new formal order-receiving.

3. A method of providing a delivery date for order-received products to a customer according to claim 1, wherein, in the step of formally allocating, the shipment guarantee value is deleted on or after a deadline delivery date for said order-receiving which is calculated from said shipment guarantee value.

4. A program of providing a delivery date for order-received products to a customer, the program causing a computer to program the steps comprising:
entering requirement information, of products, from the customer;
providing the customer a shipment guarantee value which is provisionally allocated to a volume of products for a order included in said requirement information;
receiving a formal order-receiving information of the products from said customer in response to said shipment guarantee value; and
formally allocating an applicable said shipment guarantee value based on the order included in said formal order-receiving information.

5. A program of providing a delivery date for order-received products to customer as set forth in claim 4, wherein, in the step of formally allocating, when said provisionally allocated shipment guarantee value exceeds the formally allocated guarantee value, a portion of the excess is used for other formal allocation, and when said provisionally allocated shipment guarantee value falls short in comparison with formal allocation, a portion of the shortage is allocated to a new formal order-receiving.

6. A program of providing a delivery date for order-received products to customer as set forth in claim 4, wherein, in the step of formally allocating, the shipment guarantee value is deleted on or after a deadline delivery date for said order-receiving which is calculated from said shipment guarantee value.

7. A computer readable recording medium having recorded therein a program for providing a delivery date for order-received products to a customer, the program causing a computer to program the steps comprising:
entering a requirement information of products from the customer;
providing to the customer a shipment guarantee value which is provisionally allocated to a volume of products for a order included in said requirement information;
receiving formal order-receiving information of the products from said customer in response to said shipment guarantee value; and
formally allocating an applicable said shipment guarantee value based on the order included in said formal order-receiving information.

8. A computer readable storage medium as set forth in claim 7, wherein, in the step of formally allocating, when said provisionally allocated shipment guarantee value exceeds the formally allocated guarantee value, a portion of the excess is used for an other formal allocation, and when said provisionally allocated shipment guarantee value falls short in comparison with formal allocation, a portion of the shortage is allocated to a new formal order-receiving.

9. A computer readable storage medium as set forth in claim 7, wherein, in the step of formally allocating, the shipment guarantee value is deleted on or after a deadline delivery date for said order-receiving which is calculated from said shipment guarantee value.
